(19) United States
(12) Patent Application Publication
(10) Pub. No.: US 2015/0257566 A1
(43) Pub. Date: Sep. 17, 2015

(54) HANDHELD UMBRELLA STAND WITH MODULAR FEATURES

(71) Applicants: Sean Tayebi, LA JOLLA, CA (US); Emily Isooda Tayebi, LA JOLLA, CA (US)

(72) Inventors: Sean Tayebi, LA JOLLA, CA (US); Emily Isooda Tayebi, LA JOLLA, CA (US)

(21) Appl. No.: 14/728,431

(22) Filed: Jun. 2, 2015

Related U.S. Application Data
(60) Provisional application No. 62/134,697, filed on Mar. 18, 2015.

(51) Int. Cl. A47G 25/12; F16M 11/24

(52) U.S. Cl. CPC A47G 25/12; F16M 11/242; F16M 11/247

(57) ABSTRACT

The various embodiments herein disclose a handheld umbrella stand with modular features comprising a collector chamber, an umbrella holder and a plurality of legs. The collector chamber comprising a drain water inlet hole at a top surface. The collector chamber comprises a drain cap at its lower surface. The umbrella holder is present at a top surface beside the drain water inlet hole. The umbrella holder has a plurality of gripping elements. The plurality of legs are embedded in the collector chamber through a single end hinge. The plurality of legs are angularly protruded to create standing structure. The umbrella holder holds an umbrella through its tip being inserted within a periphery of the gripping elements. The droplets of water from the umbrella is down-poured to the collector chamber through the inlet hole and is drained by opening the drain cap.

### BACKGROUND

1. Technical Field of Invention

The embodiments herein generally relate to a personal utility device and particularly relates to a portable umbrella stand or umbrella water collector. The embodiments herein more particularly relate to a portable handheld umbrella stand with multiplicative features i.e. multiple units of the said umbrella stand are combined to create a batch of multiple umbrella holders.

2. Description of Related Art

An umbrella stand is a storage cabinet for umbrellas and walking sticks. Usually to be found in the hall at the entrance of a home or at the entry point of a building. In the most complex shape they are complemented with a hanger, a mirror and the umbrella container itself. At home the umbrella stand is used to hold umbrellas when not in use. In offices, the use is limited to rainy days when employees and visitors need to carry an umbrella: By folding and inserting the closed umbrellas upon entering the building and collecting them again when leaving the building. The action in this case is to prevent entering the wet umbrella in the building wetting the floor all over.

One of the prior arts discloses a portable, absorbable umbrella stand including a hard casing for supporting an umbrella, a nylon case containing a drawstring, the case being attached to the casing for enclosing the umbrella, a sponge for collecting water, and fold-up legs attached to the casing for supporting the umbrella stand.

Another prior art discloses an umbrella stand having a tube with an axial lumen, a top, a bottom, and the top capable of receiving a pole into the axial lumen; a removable lever; the top being able to receive and release the removable lever; and the bottom capable of securing the tube into the ground. A first hole and a second hole are oppositely positioned on the side of the tube and the removable lever comprises a cylindrical rod capable of fitting through the first and second hole. A grip screw is coupled to the side of the tube and capable of securing the pole in the tube, an annular shim is placed in the stand, the bottom of the stand is a grooved spiral and latches are coupled to the stand and capable of holding the removable lever.

However, the conventional umbrella stands are slightly bulkier in nature and devised for use in specific places, such as sand umbrella stands are limited in their use to sandy surfaces only. The office and home umbrella stands are bulkier and non-portable in nature.

In the view of the foregoing, there is a need for an umbrella with stand incorporating generic and modular features and having capability of being implemented over various surfaces.

The above mentioned shortcomings, disadvantages and problems are addressed herein, as detailed below.

### SUMMARY OF THE INVENTION

The primary object of the embodiments herein is to provide an umbrella holding stand with modular features wherein the umbrella stand collects the water pouring down a wet umbrella.

Another object of the embodiments herein is to provide an array based umbrella stand with modular features in such a way that each unit from the array acts as an independent stand.

Yet another object of the embodiments herein is to provide an umbrella with multi-terrain utility.

The various embodiments herein disclose an umbrella stand with modular features comprising a collector chamber, an umbrella holder and a plurality of legs. The collector chamber comprises a drain water inlet hole on a top surface and an outlet hole on the bottom surface. The collector chamber comprises a drain cap on its lower surface. The outlet hole is covered with a drain cap. The umbrella holder is present on the top surface of the collector chamber. The umbrella holder is present beside the drain water inlet hole on the top surface of the collector chamber. The umbrella holder has a plurality of gripping elements. A plurality of legs are embedded in the collector chamber through a single end hinges. The plurality of legs are angularly protruded to create standing structure. The umbrella holder holds an umbrella. The umbrella holder holds an umbrella through a tip portion of the umbrella. The tip portion of the umbrella is being inserted within a periphery of the gripping elements. The droplets of water from the umbrella are down-poured to the collector chamber through the inlet hole and are drained out by opening the drain cap.

According to an embodiment herein, the gripping element are horizontally stretchable to house a conical head or a cylindrical head or a polygonal head of an umbrella.

According to an embodiment herein, an adhesive is applied on an outer surface of the collector chamber to combine multiple units of the umbrella stand to create an array for holding multiple umbrellas.

According to an embodiment herein, the plurality of legs are angularly protrudable elapsing an angle of 0° to 90° against a vertical axis.

According to an embodiment herein, the plurality of legs comprises an elastomeric bottom for creating a high frictional force or a vacuum over a slippery surface.

According to an embodiment herein, the top surface of the collector chamber has a slope towards the inlet hole.

According to one embodiment herein, the umbrella stand is attached at an end of a shaft of an umbrella through an adhesive or a screw mechanism or a tape mechanism.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanying drawings in which:

FIGS. 1a and 1b are front and side perspective views of the umbrella stand unit, according to the embodiments herein.

FIGS. 2a and 2b are bottom views of the collector chamber 101 having a drain cap 105, wherein FIG. 2a shows an open position of the collector chamber 101 while FIG. 2b shows a closed position of the collector chamber 101, according to the embodiments herein.

FIG. 3 illustrates an implementation of the umbrella stand as an indoor stand, according to one embodiment herein.

FIG. 4 illustrates an implementation of the umbrella stand as an umbrella head, according to one embodiment herein.

### DETAILED DESCRIPTION OF THE DRAWINGS

In the following detailed description, a reference is made to the accompanying drawings that form a part hereof, and in which the specific embodiments that may be practiced is shown by way of illustration. The embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

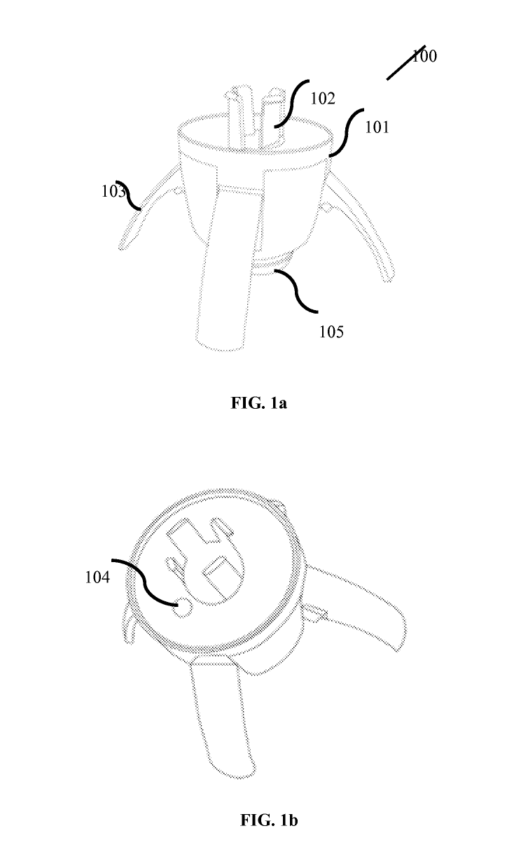

FIGS. 1a and 1b are the front and the side perspective views of the umbrella stand unit, according to the embodiments herein. With respect to FIGS. 1a and 1b, umbrella stand 100 with modular features comprises a collector chamber 101, an umbrella holder 102 and a plurality of legs 103. The collector chamber 101 comprises a drain water inlet hole 104 on a top surface. The collector chamber 101 comprises an outlet hole covered with drain cap 105 on a lower surface. The umbrella holder 102 is present on a top surface of the collector chamber 101 beside the drain water inlet hole 104. The umbrella holder 102 has a plurality of gripping elements. The plurality of legs 103 are embeddedly fixed with the collector chamber 101 with the help of single end hinges. The plurality of legs 103 are angularly protruded to create standing structure as shown in the Figs. There are at least three legs as per an embodiment herein. The umbrella holder 102 holds an umbrella from a tip portion being inserted within a periphery of the gripping elements. The water droplets from the wet umbrella when held in the umbrella stand unit get down-poured inside the collector chamber 101 through the inlet hole 104 and are drained out by opening the drain cap.

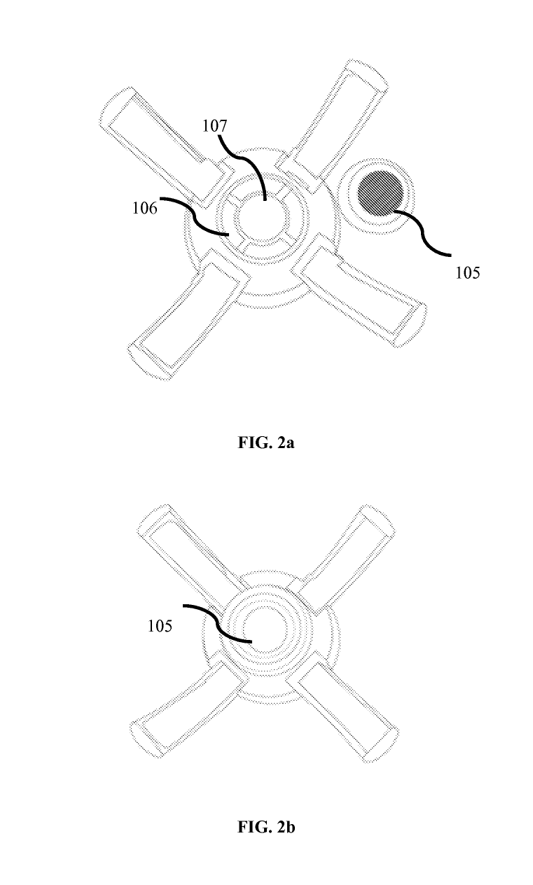

FIGS. 2a and 2b are the bottom views of the collector chamber 101 having a drain cap 105, wherein FIG. 2a shows an open position of the collector chamber 101 while FIG. 2b shows a closed position of the collector chamber 101, according to the embodiments herein. With respect to FIGS. 2a and 2b, the collector chamber 101 comprises a hollow space 107 and outlet hole 106. A drain cap 105 fixes on the outlet hole 106. The water drained from the umbrella is stored temporarily in the collector chamber in the hollow space 107 and is then drained out from the outlet hole 106.

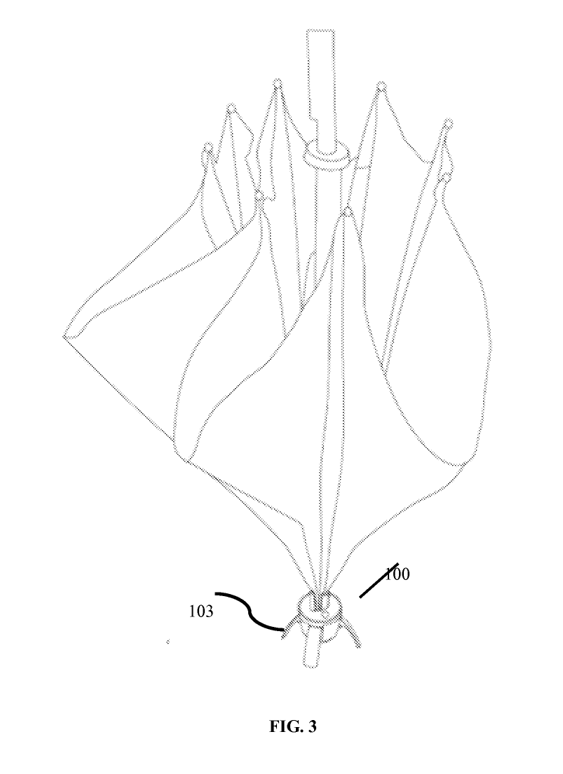

FIG. 3 illustrates an implementation of the umbrella stand as an indoor stand, according to one embodiment herein. With respect to FIG. 3, an umbrella is placed vertically or in an inclined fashion over the umbrella stand 100. The gripping elements of the umbrella stand 100 hold the umbrella to its position through a head provided in the umbrella. The plurality of legs 103 of the umbrella stand stick to a surface in a symmetrical as well as asymmetrical manner. The symmetrical stature of the plurality of legs is achieved during a vertical placement of the umbrella, wherein all the legs are protruded at equal angles. The asymmetrical stature of the plurality of legs is achieved during an inclined placement of the umbrella into the gripping elements, wherein few legs are protruded at higher angle than others to support a weight imbalance caused due to inclined placement.

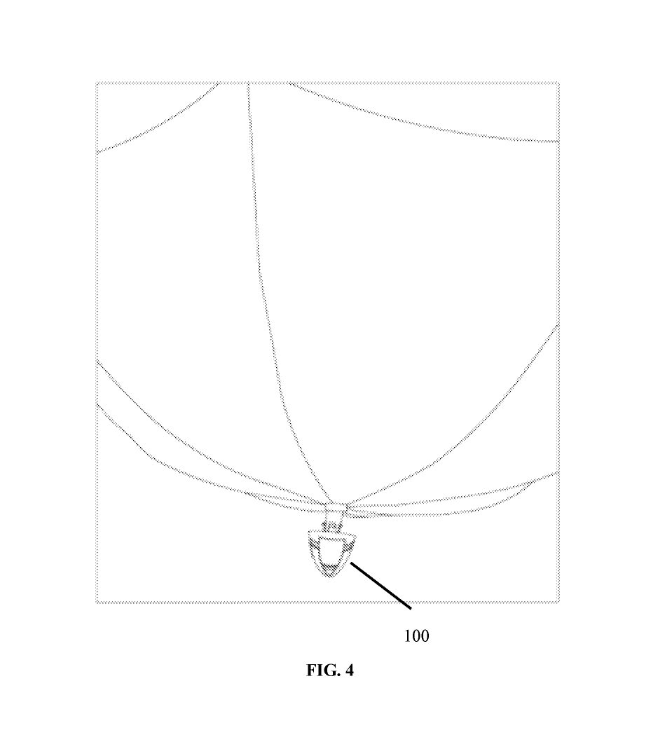

FIG. 4 illustrates an implementation of the umbrella stand as an umbrella head, according to one embodiment herein. The umbrella stand 100 forms an integral part of the umbrella head as shown in FIG. 4.

The umbrella stand provides a portable and least complex structure to support and drain a wet umbrella. Also multiple umbrella stands are joined to form an array which creates a multi-stand structure to be used in crowded places and offices.

The gripping elements are horizontally stretchable to house a conical head or a cylindrical head or a polygonal head of an umbrella. The adhesive is applied on an outer surface of the collector chamber to combine multiple units of the umbrella stand to create an array for holding multiple umbrellas. The plurality of legs are angularly protrudable elapsing an angle of 0° to 90° against a vertical axis. The plurality of legs comprises an elastomeric bottom for creating a high frictional force or a vacuum over a slippery surface. The top surface of the collector chamber has a slope towards the drain water inlet hole.

According to one embodiment herein, the umbrella stand is built with a transparent glass material with an illuminating attachment. The illuminating attachment comprises a battery inside the housing of the umbrella water collector or stand and a LED bulb.

According to one embodiment herein, the umbrella stand is made up of a glass or a wood or a metal or an alloy or a hardened polymer.

The umbrella water collector can replace the stick at the end of the shaft of the umbrella, according to one embodiment herein. The stick prevents fabric touching the ground. The umbrella water collector replaces the stick totally. The umbrella water collector is attached to end of the fabric by glue or screw. The umbrella water collector is made with light color plastics and LED light is added. The batteries are placed inside the wall of the collector. The collector is made up of different materials such as plastic, wood, aluminium or combination thereof.

It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims.

I claim:

1. A handheld umbrella stand with modular features comprises:
a collector chamber, wherein the collector chamber comprises a drain water inlet hole on a top surface and an outlet hole on a lower surface;
an umbrella holder, wherein the umbrella holder is present on the top surface of the collector chamber, wherein the umbrella holder is present beside the drain water inlet hole, wherein the umbrella holder has a plurality of gripping elements;
a plurality of legs, wherein the plurality of legs are embeddedly fixed in the collector chamber through single end hinges;
wherein, the plurality of legs are angularly protruded to create a standing structure, wherein the umbrella holder holds an umbrella through a tip portion of the umbrella, wherein the tip portion of the umbrella is being inserted within a periphery of the gripping elements, wherein a water droplets from the umbrella is down-poured in the collector chamber through the drain water inlet hole and is drained out from the outlet hole.

2. The umbrella stand according to claim 1, wherein the outlet hole is closed with a drain cap.

3. The umbrella stand according to claim 1, wherein the gripping elements are horizontally stretchable to house a conical head or a cylindrical head or a polygonal head of an umbrella.

4. The umbrella stand according to claim 1, wherein an adhesive is applied on an outer surface of the collector chamber to combine multiple units of the umbrella stand to create an array for holding multiple umbrellas.

5. The umbrella stand according to claim 1, wherein the plurality of legs are angularly protrudable elapsing an angle of 0° to 90° against a vertical axis.

6. The umbrella stand according to claim 1, wherein the plurality of legs comprises an elastomeric bottom for creating a high frictional force or a vacuum over a slippery surface.

7. The umbrella stand according to claim 1, wherein the top surface of the collector chamber has a slope towards the drain water inlet hole.

8. The umbrella stand as claimed in claim 1, wherein the umbrella stand is attached at an end of a shaft of an umbrella through an adhesive or a screwing mechanism or a taping mechanism.
